(19) United States
(12) Patent Application Publication
(10) Pub. No.: US 2026/0016096 A1
(43) Pub. Date: Jan. 15, 2026

(54) DEVICE FOR A VALVE IN PROCESS FLUID TECHNOLOGY

(71) Applicant: GEMÜ Gebr. Müller Apparatebau GmbH & Co. Kommanditgesellschaft, Ingelfingen (DE)

(72) Inventors: Michael Klemt, Pfedelbach (DE); Thomas Rüeck, Rosenberg (DE)

(21) Appl. No.: 18/997,920

(22) PCT Filed: Jul. 31, 2023
(86) PCT No.: PCT/EP2023/071108

§ 371 Date: Jan. 23, 2025

(30) Foreign Application Priority Data
Jul. 29, 2022 (DE) 10 2022 119 086.2

(51) Int. Cl. F16K 7/16; F16K 31/02; F16K 37/00

(52) U.S. Cl. CPC F16K 7/16; F16K 31/02; F16K 37/0041

(57) ABSTRACT

A device for a valve in process fluid technology includes a sealing element which interacts with a movable shut-off body of the valve or itself provides the shut-off body, and which comprises a plurality of functional regions. The device includes at least one electrically conductive elastomer portion which is associated with the sealing element and which is assigned, at least in portions, to one of the plurality of functional regions. The device also includes an operating unit which is designed to operate the electrically conductive elastomer portion.

### DESCRIPTION

The invention relates to a device for a valve in process fluid technology.

Tight maintenance schedules and cyclical inspections of process plants are the current prior art.

The problems of the prior art are solved by a device according to claim 1 and by a method according to a coordinate independent claim.

A first aspect of the description relates to a valve in process fluid technology, comprising: a sealing element which interacts with a movable shut-off body of the valve or itself provides the shut-off body, and which comprises a plurality of functional regions; at least one electrically conductive elastomer portion which is associated with the sealing element and which is assigned, at least in portions, to one of the plurality of functional regions; and an operating unit which is designed to operate the electrically conductive elastomer portion.

The elastomeric property allows the elastomer portion to be arranged in regions that are subject to static or dynamic mechanical stress. By measuring the electrical resistance, different states of the sealing element or the valve can be determined. Advantageously, additional functions such as heating or a state of the sealing element can be provided at slightly increased production costs.

Advantages are achieved in that the electrically conductive elastomer portion is integrally bonded to the sealing element.

Assembly is thus advantageously simplified.

It is advantageous, for example, that the at least one electrically conductive elastomer portion alternately covers a static functional region and a dynamically loaded functional region or alternately runs through the static functional region and the dynamically loaded functional region.

Advantageously, the position of the electrically conductive elastomer portion is ensured by the arrangement in the static functional region. The influence of the flow movements of the elastomer material induced by the mechanical stress is reduced by this course and the conductive elastomer portion is held in its position. Dynamic changes in the sealing element become measurable only by the very passing in portions through the dynamic portion. In this way, the current operating state of the valve can be determined.

It is advantageous, for example, that at least two electrical contacts, which are electrically conductively connected to different portions of the electrically conductive elastomer portion, are arranged on a narrow side of the sealing element or are led out of the sealing element at a tab protruding from the narrow side.

Advantageously, the electrically conductive elastomer portion can be contacted at a single point. For example, a connector can be provided to simplify assembly.

It is advantageous that the operating unit is designed to determine a time course of an electrical resistance of at least a section of the electrically conductive elastomer portion and to determine at least one state of the sealing element or the valve depending on the determined time course of the electrical resistance.

It is advantageous, for example, that a third electrically conductive elastomer portion is arranged at least in portions between a first electrically conductive elastomer portion and a second electrically conductive elastomer portion, the electrical resistance of which third electrically conductive elastomer portion drops more sharply under the action of pressure than the electrical resistance of the first and second elastomer portions.

This advantageously allows for determining the location of compression.

It is advantageous, for example, that the sealing element has an elastomeric, electrically insulating main body, to which the at least one electrically conductive elastomer portion is integrally bonded; in particular, the at least one electrically conductive elastomer portion is glued or vulcanized into the main body.

Advantageously, the electrically conductive elastomer portion is integrated into the sealing element and assembly is simplified in comparison to a multi-part design.

Advantageously, the state of the sealing element can be inferred from the measured electrical resistance. This makes it possible to detect critical wear states before the sealing element fails. This makes predictive maintenance possible and avoids unnecessary replacements of the sealing element, which would involve costly shutdowns of the process plant.

It is advantageous, for example, that the operating unit and the electrically conductive elastomer portion are designed to supply the electrically conductive elastomer portion with electrical energy such that the electrically conductive elastomer portion generates thermal energy.

Advantageously, the temperature in the region of the sealing element can be increased via the electrically conductive elastomer portion.

Advantages are achieved in that the static functional region is a clamping portion of a sealing element designed as a valve membrane, the clamping portion acting to produce a sealing effect toward the outside, and wherein the dynamic functional region comprises a movable deformation zone of the valve membrane, the deformation zone being located within the clamping portion and adjoining the clamping portion.

For example, it is advantageous that the operating unit is designed to determine an opened state of the valve when a signal pattern associated with an opening movement of the valve is detected in the time course of the electrical resistance.

For example, it is advantageous that the operating unit is designed to determine a closed state of the valve when a signal pattern associated with a closing movement of the valve is detected in the time course of the electrical resistance.

In another example, it is thus advantageous that a relative change in the electrical resistance is used as a basis for determining the state.

Advantageously, drift compensation is thus provided in order to compensate for the changes in signal level that occur when electrically conductive elastomers are subjected to voltage loads.

For example, it is advantageous that the operating unit is designed to detect a wear state of the sealing element when a moving average increases over a predefined period of time.

The electrical resistance of the electrically conductive elastomer portion is subject to drift. Specifically, this means that, in an installed state of the elastomer portion mentioned, the average value of the resistance value decreases over a longer period of time. Wear in the region of the elastomer portion becomes noticeable as a reversal of drift. Accordingly, wear can be determined by detecting such a reversal of drift. A rising moving average indicates said reversal of drift.

It is advantageous, for example, that the operating unit is designed to determine at least one multi-dimensional coordinate, which is characterized by increased compressive stress, depending on resistance measurements at the first and second elastomer portions.

Advantageously, this allows for calculating coordinates that are associated with increased compressive stress on the sealing element. This makes it easy to monitor tightness toward the inside and toward the outside, even during operation.

For example, it is advantageous that the third electrically conductive elastomer portion is assigned to one of the plurality of functional regions, in particular lies at least 50% within an assigned boundary imagined as a result of the assigned functional region.

By being assigned to a functional region, the third elastomer portion covers this functional region either continuously or in portions in a continuous region. The pressure-dependent electrical resistance can thus be reduced only by pressing on the third elastomer portion that covers the functional region. This increases measurement accuracy since other functional regions are covered either only partially or not at all, thereby reducing their influence on the measurement.

An advantageous example is characterized in that the operating unit is designed to determine a fault state associated with the sealing element, if the determined compressive stress coordinate lies outside a predetermined multi-dimensional specification.

Advantageously, this makes it easy to detect asymmetrical compressive stresses, for example. The detection of unwanted compressive stresses on the sealing element in regions where no compressive stress is to be expected can thus also be easily detected as a fault state.

A second aspect of the description relates to a method for operating at least one electrically conductive elastomer portion of a device for a valve in process fluid technology, the device comprising: a sealing element which interacts with a shut-off body of the valve or itself provides the shut-off body, and which comprises a plurality of functional regions; and at least one electrically conductive elastomer portion which is associated with the sealing element and which is assigned, at least in portions, to one of the plurality of functional regions; and the method comprising: operating, by means of an operating unit, the electrically conductive elastomer portion.

Reference is made below to the figures.

FIG. 1 shows a schematic representation of a device 10 for a valve 20 in process fluid technology. It comprises: a sealing element 100, which in the present case is designed as a membrane and itself provides the shut-off body 32. The sealing element 100 comprises a plurality of functional regions 110, 120 and at least one electrically conductive elastomer portion 200 which is associated with the sealing element 100 and is assigned, at least in portions, to at least one of the plurality of functional regions 110, 120. An operating unit 300 is designed to operate the electrically conductive elastomer portion 200.

One example is directed to the operating unit 300 and the electrically conductive elastomer portion 200 being designed to supply the electrically conductive elastomer portion 200 with electrical energy such that the electrically conductive elastomer portion 200 generates thermal energy.

The at least one electrically conductive elastomer portion 200 comprises an elastomer material to which at least one additive or aggregate such as soot particles or carbon particles is added in order to produce the electrical conductivity.

The sealing element 100 has an elastomeric, electrically insulating main body, to which the at least one electrically conductive elastomer portion 200 is integrally bonded; in particular, the at least one electrically conductive elastomer portion 200 is glued or vulcanized into the main body.

The mechanical stresses acting on the elastomer portion 200 designed as a measuring path include tensile, compressive, bending, shear and torsional stresses and are characterized by the action of forces and torques on the assigned functional region 110, 120. They lead to mechanical stresses and deformations of the measuring path and are detected via the measured resistance of the elastomer portion 200 and its course.

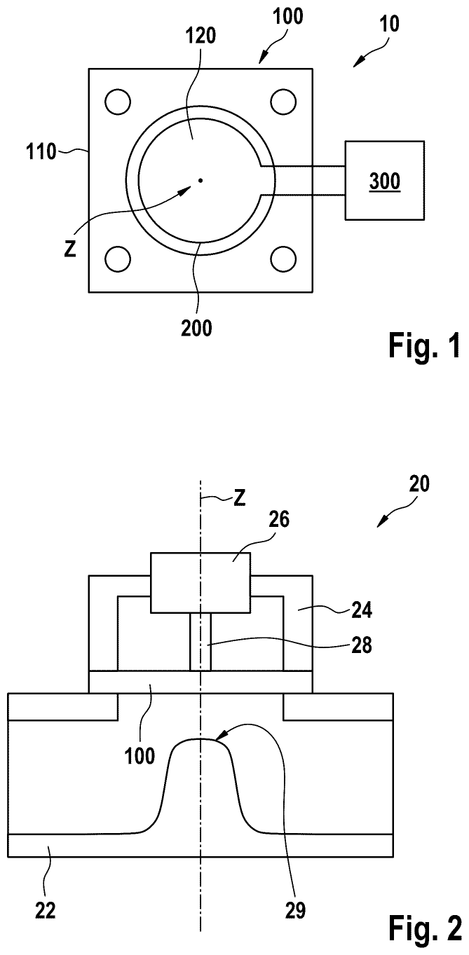

FIG. 2 shows a situation in which the sealing element 100 of FIG. 1 designed as a valve membrane is installed in a valve 20 designed as a diaphragm valve. The sealing element 100 is clamped between the valve body 22 and a drive-side body 24. A drive 26 rigidly connected to the drive-side body 24 is connected in a force-transmitting manner to a central portion of the sealing element 100 via a valve rod 28 and moves the central portion along an actuating axis z toward or away from a valve seat 29.

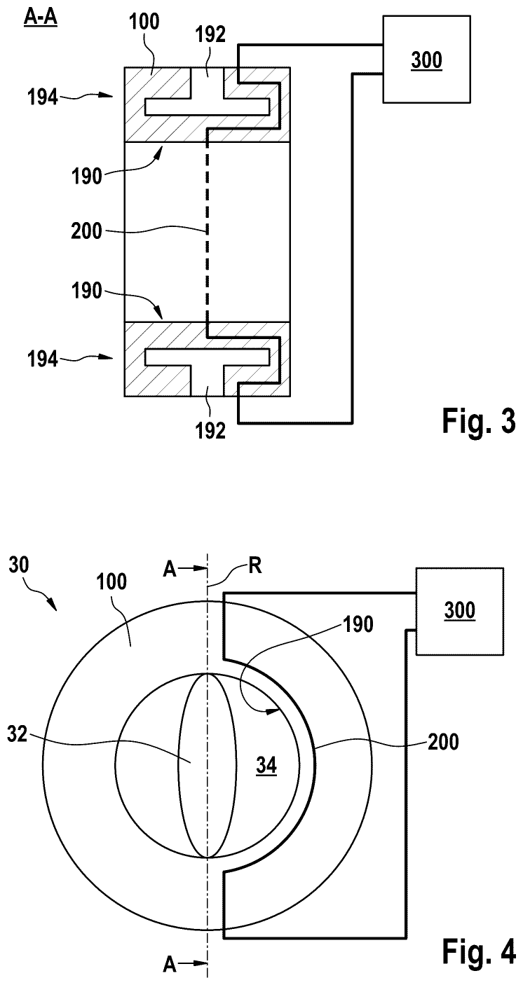

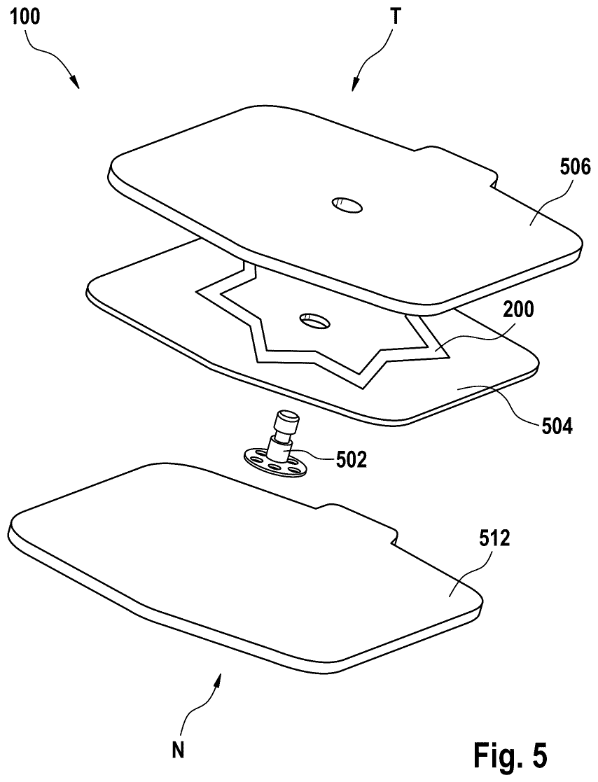

FIGS. 3 and 4 show another example of the device 100 using the example of a sealing sleeve as a sealing element 100 for a shut-off valve as valve 30. As regards the remaining features, reference is made to FIGS. 1 and 2. A schematic section A-A is shown in FIG. 3. Section A-A runs along a rotation axis R of a rotatable flap 32 arranged in a fluid channel 34, wherein the flap 32 is arranged within the sealing sleeve and represents the movable shut-off body. In contrast to FIG. 1, the electrically conductive elastomer portion 200 runs through the dynamically loaded functional region 190, following a semicircular shape. When closed and during the closing movement, the flap 32 acts on the functional region 190. The rigid flap 32 thus ensures internal tightness. An externally accessible opening 192 of the sealing sleeve extends along the circumference of the sealing sleeve and provides a receptacle for a counterpart of a flap body engaging therein. A static functional region 194 of the sleeve, which laterally adjoins the dynamically loaded functional region 190, is not deformed during operation or is deformed to a lesser extent than the dynamically loaded functional region 190 and establishes the mechanical connection of the dynamic functional region 190 in the direction of the flap body.

FIG. 5 shows a schematic exploded view of components of the sealing element 100 of FIGS. 1 and 2 designed as a valve membrane. Hereinafter, despite the visual representation before vulcanization, reference is made to the design of the sealing element 100 as a vulcanized membrane. The electrically conductive elastomer portion 200 is integrally bonded to the sealing element 100.

In the present example, a drive-side end of a membrane pin 502 is guided after vulcanization through central through-openings of a reinforcement 504, designed as a fabric, and an elastomer layer 506 arranged toward a dry side T. The membrane pin 502 provides the mechanical interface to the valve rod, thus connecting the valve rod, which is moved along its longitudinal axis by the drive, to the internal reinforcement 504. An elastomeric layer 512 adjoins the reinforcement 504 toward the wet side N. The elastomer portion 200 is thus vulcanized together with the other insulating membrane layers. The electrically conductive elastomer portion 200 is located on the side of the reinforcement that is oriented toward the dry side T.

As an alternative to the integrally bonded connection shown, the electrically conductive elastomer portion is part of a separate sensor layer, which is arranged on the dry side of the sealing element. Another alternative example provides for the electrically conductive elastomer portion to be inserted into a recess in the sealing body.

The elastomer portion 200 is arranged on a side of the reinforcement 504 that faces away from the wet side N. Advantageously, the function of the inner sealing region is less affected by the structuring of the membrane that is caused by the elastomer portion 200.

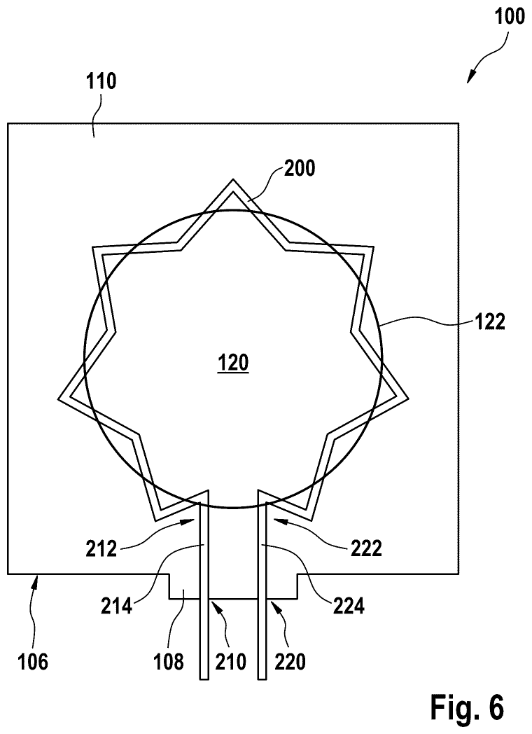

FIG. 6 shows a section of the sealing element 100 of FIG. 5 that is perpendicular to the actuating axis. It is shown that the at least one electrically conductive elastomer portion 200 alternately covers a static functional region 110 and a dynamically loaded functional region 120 or alternately runs through the static functional region 110 and the dynamically loaded functional region 120.

The statically loaded functional region 110 is a clamping portion of a sealing element 100 designed as a valve membrane, the clamping portion acting to produce a sealing effect toward the outside, wherein the dynamic functional region 120 comprises a movable deformation zone of the valve membrane, the deformation zone being located within the clamping portion and adjoining the clamping portion.

The course of the electrically conductive elastomer portion 200 follows a circular ring shape and follows the circumference of the dynamically loaded functional region 120 at least for a quarter, in particular at least for two thirds, in particular at a distance. The electrically conductive elastomer portion runs at least 50%, in particular at least 60% and in particular at least 70% through the dynamic functional region 120.

The functional regions 110 and 120 are separated from each other by a sealing boundary or sealing edge 122.

In the case of the membrane, the electrically conductive elastomer portion 200 thus meanders between the statically loaded clamping region and the dynamically loaded clamping region above and along the sealing edge 122.

The example shows that at least two electrical contacts 210, 220, which are electrically conductively connected to different portions 212, 220 of the electrically conductive elastomer portion 200, are arranged on a narrow side 106 of the sealing element 100 or are led out of the sealing element 100 at a tab 108 protruding from the narrow side 106.

Between each contact 210, 220 and the assigned portion 212, 220 of the electrically conductive elastomer portion 200 is located a respective connecting electrical line 214, 224.

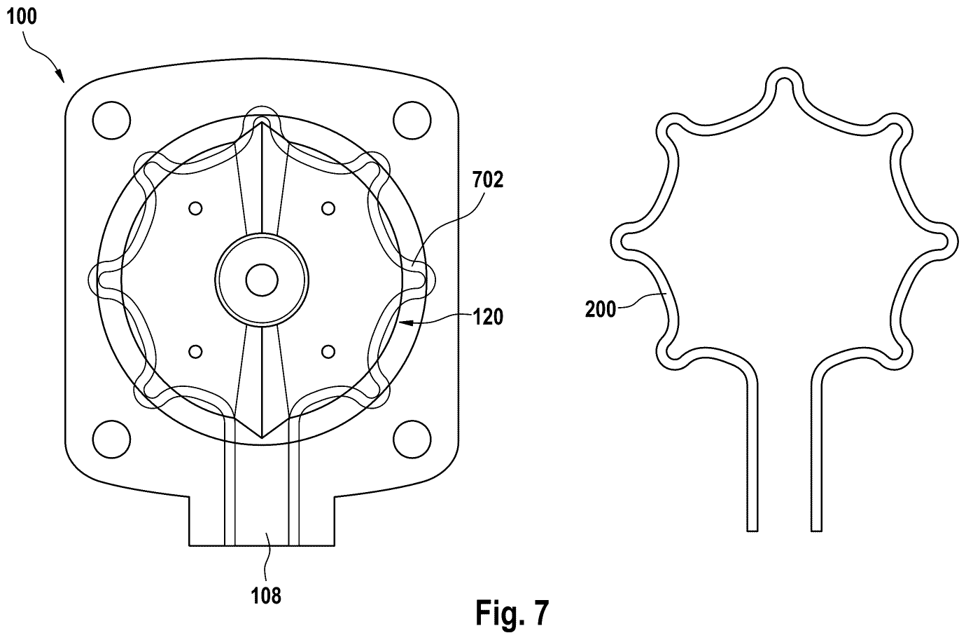

FIG. 7 shows on the left a vulcanized sealing element 100 designed as a valve membrane with a recess 702 into which the vulcanized elastomer portion 200 is received, for example glued or vulcanized. In this case, a surface of the elastomer portion 200 can be exposed. The elastomer portion 200 is thus integrally bonded to the sealing element 100 in portions. Starting from the tab 108, the recess 702 runs over the static functional region 110 in the direction of the dynamic functional region 120, meanders around the dynamic functional region 120 as shown in FIGS. 5 and 6, and then reaches the tab 108 again after passing through the static functional region 110. The recess 702 runs alternately in the functional regions 110 and 120, wherein the sealing edge 122 is passed over several times.

The course of the electrically conductive elastomer portion 200 encloses an angle between 45° and 5°, in particular between 35° and 15°, with an imaginary vertical of the sealing edge between the static and the dynamic functional regions. The electrically conductive elastomer portion 200 thus advantageously does not run along a heavily stressed region, but rather along the region of the sealing edge that is stressed by tension and pressure in the membrane plane.

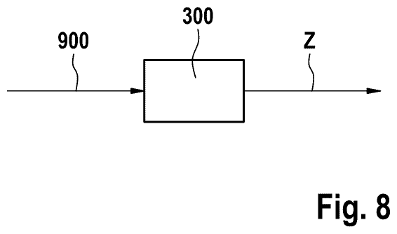

FIG. 8 shows a schematic block diagram of the operating unit 300. It is shown that the operating unit 300 is designed to determine a time course 900 of the electrical resistance of at least a section of the electrically conductive elastomer portion 200 and to determine at least one state Z of the sealing element 100 or the valve 20, 30 depending on the determined time course 900 of the electrical resistance.

An opened state Z of the valve is determined when a first signal pattern associated with an opening movement of the valve is detected in the time course 900 of the electrical resistance.

For detecting the first signal pattern in the time course 900, at least one data set representing the first signal pattern is, for example, determined and stored in advance. A first filter is used to determine the presence of the temporal position or to determine the temporal position of the first signal pattern or the previously determined signal shape within the course.

In another example, the one-time detection of rising or falling edges or a predetermined sequence of rising or falling edges of the course 900 is sufficient to infer the opening movement of the valve.

A closed state Z of the valve is determined when a second signal pattern associated with a closing movement of the valve is detected in the time course 900 of the electrical resistance. The first and the second signal pattern are different from each other.

For detecting the second signal pattern in the time course 900, at least one data set representing the second signal pattern is, for example, determined and stored in advance. A second filter is used to determine the presence of the temporal position of the second signal pattern or the previously determined signal shape within the course 900.

In another example, the one-time detection of rising or falling edges or a predetermined sequence of rising or falling edges of the course 900, which represent the second signal pattern, is sufficient to infer the closing movement.

The operating unit 300 is thus designed to determine the current state Z of the valve by means of signal processing steps.

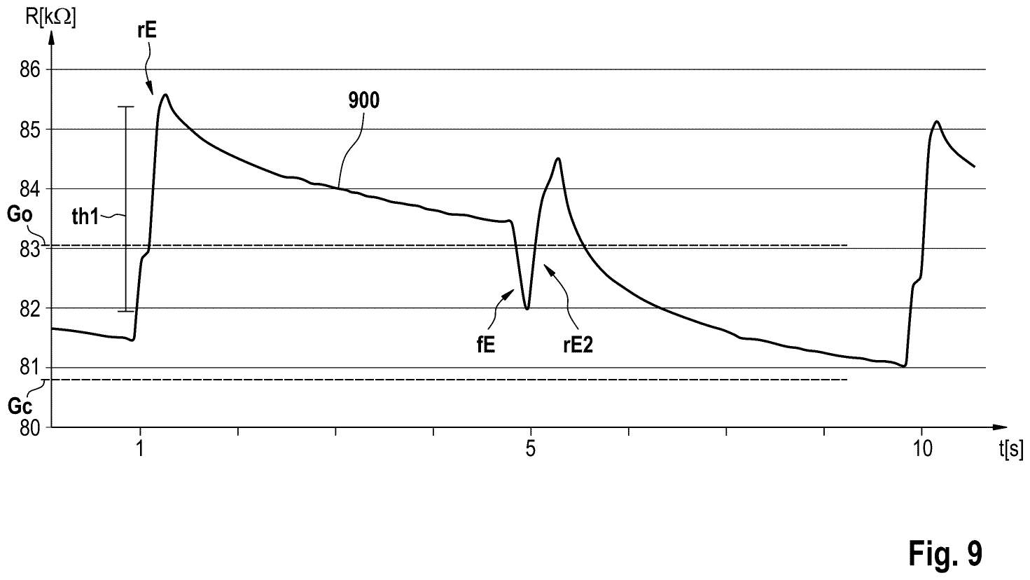

FIG. 9 shows a course 900 of the resistance R of the electrically conductive elastomer portion that is measured using the arrangement of FIG. 7. The figure shows that the operating unit is designed to determine an opened state of the valve 20, 30 when a rising edge rE in the time course 900 of the electrical resistance exceeds an assigned threshold distance th1. In the example, the rising edge rE occurs within an expected time span of, for example, 0 to 1 s, in particular between 0.25 and 0.75 seconds, but depends on the size of the diaphragm valve and on the drive. The rising edge rE represents the first signal pattern associated with the opening movement of the valve, which signal pattern is detected in the course 900.

Additionally or alternatively, a limit value Go is determined during operation, which limit value characterizes the opened state and toward which limit value the value of the electrical resistance tends in an opened state of the valve. Based thereon, the opened state can, for example, be determined if the resistance is above the limit value Go for a predetermined period of time, for example several seconds.

The operating unit 300 is designed to determine a closed state of the valve 20, 30 when another rising edge rE2 in the time course of the electrical resistance follows a falling edge fE, in particular immediately. The edges fE and rE2 represent the second signal pattern associated with the closing movement of the valve, which signal pattern is detected in the course 900.

Additionally or alternatively, the previous first limit value Go can be determined for determining the closed state. If the value of the resistance after the edges fE, rE2 remains below the first limit value G2o for a predetermined period of time of, for example, 1-2 seconds, in particular with an additional distance, then the state of the valve is determined to be closed.

Additionally or alternatively, a second limit value Gc can be determined during operation, toward which second value the value of the resistance tends in the closed state. The second limit value Gc is smaller than the first limit value Go.

For determining the first and/or second limit values Gc, Go, a predefined function can be used, which determines the respective limit value Gc, Go during operation from the time course 900 of the resistance. This compensates for the drift inherent in the resistance signal.

The course 900 shown in FIG. 9 is linked to the design of the sealing element 100 of FIG. 7. Accordingly, for other geometric aspects of the course of the electrically conductive elastomer portion 200, a different course 900 of the electrical resistance is expected, for which other first and second signal patterns are expected than those previously described.

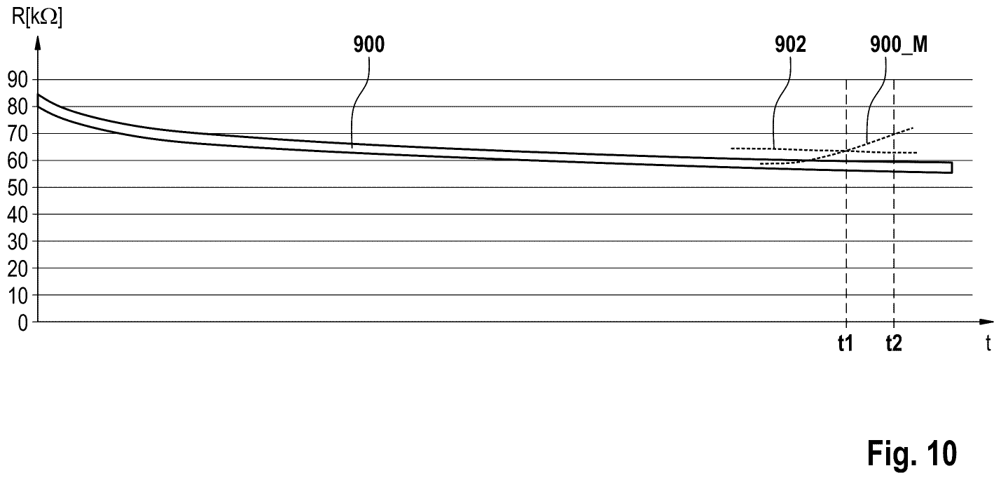

FIG. 10 shows the course 900 of the electrical resistance over a plurality of switching cycles, which is why the diagram shows a bar form. For example, it is shown that a relative change in electrical resistance is used as a basis for determining the state. The relative change in electrical resistance of the electrically conductive elastomer portion is made possible, for example, by forming an average value 900_M of the resistance value over a period of time comprising several closing and opening cycles. The deviations of the resistance signal from this average value 900_M are then used as the resistance signal for assessing the state.

For example, it is shown that the operating unit is designed to detect a wear state of the sealing element 100 when a moving average in terms of the average value 900_M increases over a predefined period of time of, for example, between 30 minutes and 3 hours.

The moving average in terms of the average value 900_M exceeds a drift-compensated threshold 902 at time t1. For example, the threshold 902 follows values of the average value 900_M from the past at a fixed distance of 3-10 kilohm. If the average value 900_M continues to rise after time t1, at which average value 900_M reaches the threshold 902, until time t2, degradation of the sealing element or of the electrically conductive elastomer portion is inferred.

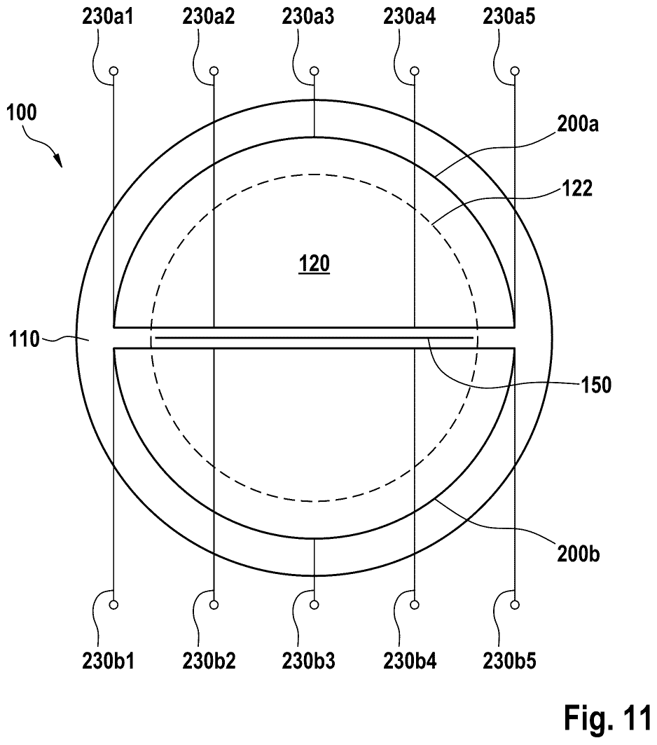

FIG. 11 schematically shows an embodiment of the sealing element 100 designed as a valve membrane. Two electrically conductive, mutually insulated elastomer portions 200a, 200b follow the outer contour of a crescent and run in the region of an axially running sealing portion 150.

Electrical lines lead from each elastomer portion 200a, 200b to the electrical contacts 230a, 230b of the respective elastomer portion via various taps.

For example, the resistance values measured between the contacts 210a1 and 210a3 can be used to check the tension of the statically loaded functional region 110 in the assigned subportion of the elastomer portion 200a, since the elastomer portion 200a runs through the functional region 110 or its subportion between the aforementioned taps. This allows for checking tightness toward the outside during operation.

One or more resistance measurements between the contacts 230b2 and 230b4 are used during operation to characterize the contact force acting, for example, on the seat. In this way, tightness toward the inside is checked.

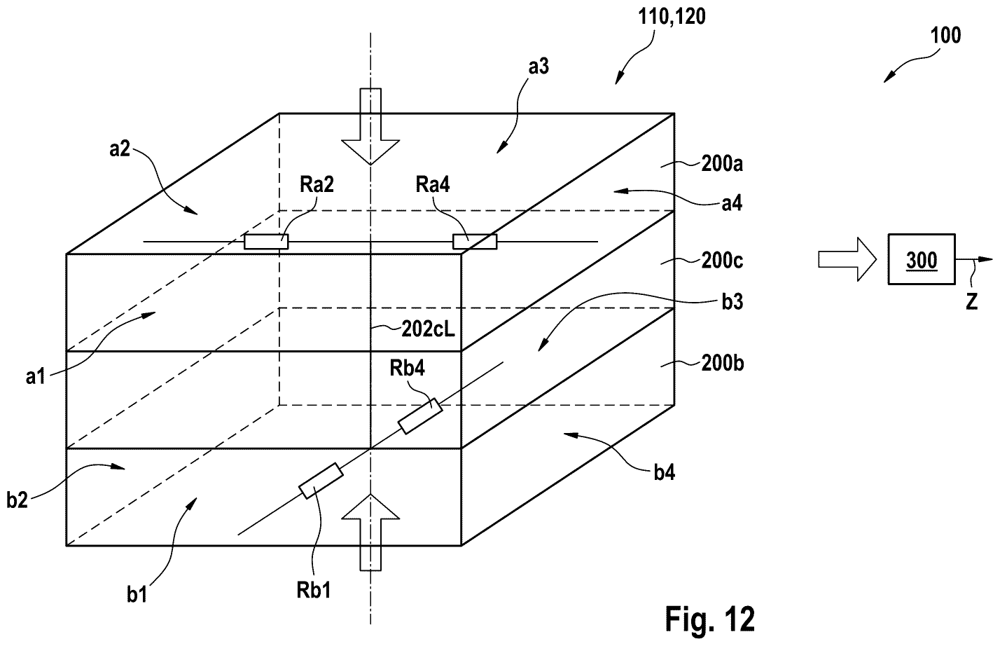

FIG. 12 shows a schematic perspective view of a section in the functional region 110 or 120 of the sealing element 100 designed as a valve membrane or sealing sleeve. It shows that the third electrically conductive elastomer portion 200c is arranged at least in portions between the first electrically conductive elastomer portion 200a and the second electrically conductive elastomer portion 200b, the electrical resistance of which third electrically conductive elastomer portion drops more sharply under the action of pressure than the electrical resistance of the first and second elastomer portions 200a, 200b.

The sealing element 100 responds to pressure, which connects the two electrically conductive elastomer portions 200a, 200b in places via the elastomer portion 200c in an electrically conductive manner and thus forms a voltage divider at which the electrical resistance is measured in order to determine the coordinate of the pressure application.

For example, it is shown that the operating unit 300 is designed to determine at least one multi-dimensional coordinate, which is characterized by increased compressive stress, depending on resistance measurements at the first and second elastomer portions 200a, 200b.

The operating unit 300 is designed to determine a fault state Z associated with the sealing element 100, if the determined compressive stress coordinate lies outside a predetermined multi-dimensional specification.

The fault state Z includes both wear states of the sealing element and assembly errors. Furthermore, operating errors such as an obstruction in the fluid channel can also be detected in this way.

In order to determine the compressive stress coordinate, a voltage is applied to one of the conductive elastomer portions 200a, 200b, for example. The voltage drops from one edge of the elastomer portion 200a, 200b to the opposite edge. At the point of the compressive stress, the voltage level of both elastomer portions 200a, 200b is the same because they are electrically connected there. Two voltages are measurable between the edge of the second elastomer portion 200a and the two opposite edges of the first elastomer portion 200a. If the two voltages are equal, the coordinate of the center between the two edges of the first elastomer portion 200a is determined. The higher one voltage is in relation to the other, the further the location of the compressive stress is from the respective edge.

The two elastomer portions 200a, 200b run flat and parallel to each other. The intermediate layer 200c, on the other hand, can alternate with electrically insulating portions.

It is shown that the third electrically conductive elastomer portion 200c is assigned to one of the plurality of functional regions 110, 120, in particular lies at least 50% within an assigned boundary imagined as a result of the assigned functional region 110, 120.

The arrows pointing toward each other represent an increased pressure on the sealing element in this region. Due to the increased pressure, the conductivity of the third elastomer portion 200c is increased in a region 202cL and a current flow occurs. This results in the schematically shown resistances Ra2, Ra4 and Rb1, Rb3 in the layered elastomer portions 200a, 200b.

In comparison to the first and second elastomer portions, the sharper drop in electrical resistance at the same pressure can for example be achieved for the third elastomer portion by increasing the concentration of soot particles mixed into the elastomer material. Accordingly, the first and the second elastomer portion have a lower concentration of soot particles than the third elastomer portion.

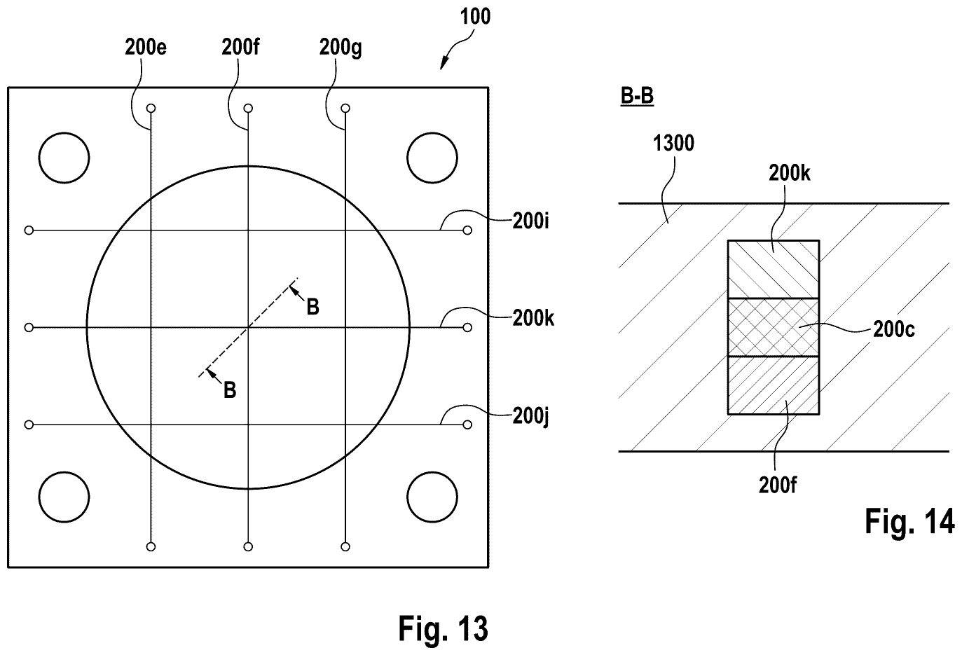

FIGS. 13 and 14 show another example of a sealing element 100 designed as a valve membrane. FIG. 13 shows a section B-B of FIG. 12. First electrically conductive elastomer portions 200i, 200k, 200j run in a first plane and second electrically conductive elastomer portions 200e, 200f, 200g run in a second plane at a distance from the first plane. The first and second elastomer portions are linear. The third elastomer portion 200c is arranged in intersecting regions between the first elastomer portion 200k and the second elastomer portion 200f. The first to third elastomer portions are embedded in an electrically insulating main elastomer body 1300. This arrangement creates discrete, spaced-apart regions that each respond to pressure. This allows the pressure distribution to be determined better.

Of course, in addition to the shown courses of the electrically conductive elastomer portion, other courses such as a wave shape, a spiral shape or other shapes are also conceivable.

Furthermore, the electrically conductive elastomer portion can also be arranged outside the sealing element 100 in a separate sensor layer or the sealing element can have no direct media contact, such as in the case of a laminated elastomer membrane with a membrane shield which is in contact with the process medium.

The electrically insulating main body has a higher electrical resistance per unit volume than the electrically conductive elastomer portion.

If the electrically conductive elastomer portion breaks, the measured resistance increases toward infinity. This makes a crack measurable. The measures presented are intended to help predict such a break by determining the state, and to help initiate an early replacement of the membrane.
1-16. (canceled)

17. A device for a valve in process fluid technology, comprising:
a sealing element which interacts with a movable shut-off body of the valve or itself provides the shut-off body, and which comprises a plurality of functional regions;
at least one electrically conductive elastomer portion which is associated with the sealing element and which is assigned, at least in portions, to one of the plurality of functional regions; and
an operating unit which is designed to operate the electrically conductive elastomer portion.

18. The device according to claim 17, wherein the electrically conductive elastomer portion is integrally bonded to the sealing element at least in portions.

19. The device according to claim 17, wherein the at least one electrically conductive elastomer portion alternately covers a static functional region and a dynamically loaded functional region or alternately runs through the static functional region and the dynamically loaded functional region.

20. The device according to claim 19, wherein the static functional region is a clamping portion of a sealing element designed as a valve membrane, the clamping portion acting to produce a sealing effect toward the outside, and wherein the dynamic functional region comprises a movable deformation zone of the valve membrane, the deformation zone being located within the clamping portion and adjoining the clamping portion.

21. The device according to claim 17, wherein at least two electrical contacts, which are electrically conductively connected to different portions of the electrically conductive elastomer portion, are arranged on a narrow side of the sealing element or on a tab protruding from the narrow side.

22. The device according to claim 17, wherein the operating unit is designed to determine a time course of an electrical resistance of at least a section of the electrically conductive elastomer portion and to determine at least one state of the sealing element or the valve depending on the determined time course of the electrical resistance.

23. The device according to claim 22, wherein the operating unit is designed to determine an opened state of the valve when a signal pattern associated with an opening movement of the valve is detected in the time course of the electrical resistance.

24. The device according to claim 22, wherein the operating unit is designed to determine a closed state of the valve when a signal pattern associated with a closing movement of the valve is detected in the time course of the electrical resistance.

25. The device according to claim 22, wherein a relative change in the electrical resistance is used as a basis for determining the state.

26. The device according to claim 22, wherein the operating unit is designed to detect a wear state of the sealing element when a moving average increases over a predefined period of time.

27. The device according to claim 17, wherein a third electrically conductive elastomer portion is arranged at least in portions between a first electrically conductive elastomer portion and a second electrically conductive elastomer portion, the electrical resistance of which third electrically conductive elastomer portion drops more sharply under the action of pressure than the electrical resistance of the first and second elastomer portions.

28. The device according to claim 27, wherein the operating unit is designed to determine at least one multi-dimensional coordinate, which is characterized by increased compressive stress, depending on resistance measurements at the first and second elastomer portion.

29. The device according to claim 27, wherein the operating unit is designed to determine a fault state associated with the sealing element, if the determined compressive stress coordinate lies outside a predetermined multi-dimensional specification.

30. The device according to claim 27, wherein the third electrically conductive elastomer portion is assigned to one of the plurality of functional regions, in particular lies at least 50% within an assigned boundary imagined as a result of the assigned functional region.

31. The device according to claim 17, wherein the sealing element has an elastomeric, electrically insulating main body, to which the at least one electrically conductive elastomer portion is integrally bonded; in particular, the at least one electrically conductive elastomer portion is glued or vulcanized into the main body.

32. The device according to claim 17, wherein the operating unit and the electrically conductive elastomer portion are designed to supply the electrically conductive elastomer portion with electrical energy such that the electrically conductive elastomer portion generates thermal energy.
